(19) United States
(12) Patent Application Publication
(10) Pub. No.: US 2010/0230946 A1
(43) Pub. Date: Sep. 16, 2010

(54) Printed matter providing optically readable information

(75) Inventor: YUKIO KANDA, Chiba-Ken (JP)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E. I. DU PONT DE NEMOURS AND COMPANY, Wilmington, DE (US)

(21) Appl. No.: 12/722,585

(22) Filed: Mar. 12, 2010

(30) Foreign Application Priority Data
Mar. 13, 2009 (JP) 061303109

(51) Int. Cl. B42D 15/00; B41J 2/01

(52) U.S. Cl. 283/85; 347/102

(57) ABSTRACT

[Problem] To provide a printed matter that provides optically readable information, has excellent durability against wind, rain, and light, and that can be produced more simply and at low cost. In addition, to provide a printed matter set that contains a plurality of the aforementioned printed matters, and a method for producing this printed matter set.

[Solution] A printed matter characterized by a non-woven fabric base material having a basis weight of 20.0-120.0 g/m² and a thickness of 0.020-0.400 mm, and optically readable information formed by printing an ultraviolet-curable ink on this base material using an inkjet printing method.

### TECHNICAL FIELD

The present invention relates to a printed matter that is suitable for use as a bib worn by marathon runners and includes a non-woven fabric base material and optically readable information, and optionally, additional visually recognizable information on this base material.

### BACKGROUND ART

Public marathons and skiing competitions have become extremely popular in recent years due to fitness booms and the like, with many citizens now taking part in this type of event. At such events, participants are given bibs that clearly display the name of the event and the competitor's number, which the competitors wear on the day of the event, but because the competitor's number is different on every bib, it is currently necessary to manually print each competitor's number on bibs on which the name of the event is already printed, resulting in problems such as increased workload and cost. Furthermore, participants have been required to register their blood type and medical history before the event in recent years in order to facilitate a rapid response in the event of a competitor being injured or involved in an accident during the event. However, due to increased concerns in recent years over the way in which personal information is handled, incorporating this type of information on each competitor's bib in such a way that the information can be retrieved rapidly when required without being divulged to other people has been considered an ideal method, but a means for doing so has not yet been devised.

Moreover, it is desirable to provide Braille on bibs for visually impaired participants, but no techniques have yet been developed for easily and rapidly producing bibs having tactilely recognizable information such as Braille.

On the other hand, inkjet printing is a technique for forming an image by firing ink at an object based on digital data, and has become widely used for published materials, poster, and the like due to having advantages such as high speed, multi-color functionality, and low noise. Forming an image by inkjet printing does not require the preparation of a block copy, which is required in offset printing, requires no thermal fixing treatment, such as electrophotographic methods used by duplicators and laser printers, meaning that inkjet printers have the advantage of having simple mechanisms. In addition, conventional offset printing requires information common to all the printed matters to be printed first and information that differs from printed matter to printed matter to then be printed one at a time, whereas inkjet printing has the advantage of enabling both information common to all the printed matters and information that differs from printed matter to printed matter to be printed at the same time.

Paper is commonly used as a base material for a printed matter on which an image is formed by inkjet printing, but if the printed material is used under relatively harsh conditions, for example if the printed matter is used outdoors, it is necessary to use a base material that has resistance to wind, rain, and light. Non-woven fabrics that are both lightweight and flexible have been proposed as this type of base material (for example, see patent document 1).

However, it is known that by providing optically readable information in a form such as a two-dimensional bar code such as a QR code, Data Matrix, PDF 417, Maxi Code, or VeriCode on a printed matter, it is possible to distinguish one printed matter from another by encoding information for which reading by an optical means is preferred.

Patent document 2 discloses a brand discrimination method characterized by using a magnetic ink to mark an embroidered or woven label with a brand name or logo, such as text, a graphic, or a symbol in order to be able to distinguish a genuine brand from a fake brand, but does not disclose a printed matter including optically readable information formed by printing on a non-woven fabric base material using inkjet printing.

Patent document 3 discloses a basic process in inkjet dyeing that uses an ink having, as a primary component, an ink for recording information such as text, an image, or an identification mark on a cloth that involves the following steps. (1) Subjecting the cloth to migration prevention treatment. (2) Using an inkjet printer and the like to cause the ink having a dye as a primary component to penetrate or disperse into the fibers of the cloth on which a temporary image is formed so as to dye the cloth. (3) Dyeing by allowing the dye that forms the temporary image to penetrate or disperse into the fibers of the cloth through the use of heat treatment and the like. (4) Removing excess dye by reduction cleaning and the like which aims to solve a variety of problems inherent in the heat treatment in (3). Specifically, patent document 3 discloses a method for producing an information fabric, characterized in that the various problems inherent in the heat treatment in (3) above are solved by forming an image such as text, an image, or an identification mark on a woven, knitted, or non-woven fabric (A) using an ink having a dye as a primary component, superposing a woven, knitted, or non-woven fabric or paper (B) on at least the face of the woven, knitted or non-woven fabric (A) on which the image is formed, and then carrying out heat treatment so as to cause the dye that forms the above-mentioned temporary image to penetrate or disperse into the fibers that constitute the woven, knitted, or non-woven fabric (A). However printing which uses the ink having a dye as a primary component used in the information fabric production method in patent document 3 requires a plurality of complicated steps, as mentioned above, which involves high cost and a number of technical drawbacks. In addition, dye-based ink methods in which waste liquids are discharged due to cleaning steps following heat treatment are disadvantageous from the perspective of environmental protection.

No techniques have yet been developed to enable simple and effective printing of information that is common to all the bibs in an event such as a public marathon, such as the name of the event, as well as information that varies from bib to bib, such as the number of a competitor, and personal information for the competitor on a single bib.

### BACKGROUND ART DOCUMENTS

### Patent Documents

[Patent Document 1] Japanese Unexamined Patent Application Publication No. H08-187933

[Patent Document 2] Japanese Unexamined Patent Application Publication No. 2004-334144

[Patent Document 3] Japanese Unexamined Patent Application Publication No. H05-247838

### SUMMARY OF THE INVENTION

### Problems to be Solved by the Invention

An object of the present invention is to provide printed matters on which information that differs from printed matter to printed matter is printed in any optically readable manner, from which the printed optically readable information can be read with good precision, which has excellent weather resistance, and which can be produced simply and at low cost.

Another object of the present invention is to provide printed matters having tactilely recognizable information that is common to each printed matter and optically readable information that varies from printed matter to printed matter.

A further object of the present invention is to provide printed matters having tactilely recognizable information that is common to each printed matter, optically readable information that varies from printed matter to printed matter, and tactilely recognizable information that varies from printed matter to printed matter.

Another object of the present invention is to provide a method that enables the production of the above-mentioned printed matters simply and at low cost.

### Means for Solving the Problems

The inventors of the present invention completed the present invention based on findings such that by printing optically readable information on a specific non-woven fabric base material by inkjet printing using an ultraviolet-curable ink, it is possible to print optically readable information extremely clearly, thereby improving the optical reading precision and solving the problems mentioned above.

Specifically, the present invention provides a printed matter including a non-woven fabric base material having a basis weight of 20.0-120.0 g/m² and a thickness of 0.020-0.400 mm and optically readable information formed by printing an ultraviolet-curable ink on this base material using an inkjet printing method.

The present invention also provides a printed matter set containing a plurality of the aforementioned printed matters, wherein each of the printed matters in the set includes optically readable information that displays information that is different from the other printed matters in the set and visually recognizable information that is common to all the printed matters in the set.

A method for producing a printed matter set consisting of a plurality of printed matters, each of which is printed with optically readable information that displays information that is different from that on the other printed matters in the set,

including a step of entering one of the aforementioned mutually differing types of information,

a step of converting the aforementioned entered information into a signal for generating optically readable information corresponding to this entered information,

a step of sending the aforementioned signal to a printing means, and

based on the aforementioned signal, a step of printing the aforementioned optically readable information on a non-woven fabric base material having a basis weight of 20.0-120.0 g/m² and a thickness of 0.020-0.400 mm with an ultraviolet-curable ink using an inkjet printing method.

### EFFECT OF THE INVENTION

According to the present invention, it is possible to provide a printed matter that includes optically readable information, has excellent durability against wind, rain, and light, and can be produced more simply and at low cost. In particular, by combining a non-woven fabric and an ultraviolet-curable ink, it is possible to provide optically readable information extremely clearly on a printed matter, thereby preventing errors from occurring when reading the optically readable information using an optical means. In addition, according to the present invention, it is possible to provide a printed matter which is printed after encoding information that can preferably be read by an optical means, and therefore possible to provide a convenient printed matter that contains information essential for the management of personal information and the like. It is also possible to produce, simply and without the need for complicated processes, a printed matter set containing a plurality of printed matters, wherein each of the printed matters in the set includes optically readable information that displays information that is different from the other printed matters in the set and visually recognizable information that is common to all the printed matters in the set. Furthermore, from the perspective of waste liquid treatment, using an ultraviolet-curable ink has a smaller environmental impact than methods involving dye-based inks and the like.

### BRIEF DESCRIPTION OF THE DRAWINGS

FIG. 1 is a diagram showing an embodiment of a bib (1) of the present invention.

FIG. 2 shows an example of a database that stores participants' numbers (individual identification information).

FIG. 3 shows enlarged photographs of a bar code and a QR Code™ on a bib prepared using a Tyvek™ non-woven fabric manufactured by E.I. DuPont (product no. 1056D) and an ultraviolet ink for inkjet printers (SD108) manufactured by E.I. DuPont.

FIG. 4 shows enlarged photographs of a bar code and a QR Code™ on a bib prepared using a Tyvek™ non-woven fabric manufactured by E.I. DuPont (product no. 1056D) and commercially available ink (inks for the Pixus 455i printer manufactured by Canon, Inc.; product names BCI-24 Color and BCI-24 Black), not an ultraviolet-curable ink.

### MODE FOR CARRYING OUT THE INVENTION

In the present invention, a non-woven fabric base material having a basis weight of 20.0-120.0 g/m² and a thickness of 0.020-0.400 mm is used as the base material on which printing is carried out. Here, the “basis weight” (g/m²) of the non-woven fabric can be measured in accordance with JIS-L1096. In addition, the “thickness” (mm) of the non-woven fabric can be measured in accordance with JIS-L1096.

The non-woven fabric having the above-mentioned characteristics used in the present invention can be a hydrophilic fiber such as cellulose or silk, a hydrophobic fiber such as a polyolefin (polyethylene, polypropylene and the like) or a mixture thereof, and can be produced using routine methods, either with or without using a binder. Of these, it is preferable to use a non-woven fabric produced using polyethylene fibers.

The basis weight of the non-woven fabric used in the present invention is preferably 30.0-100.0 g/m², more preferably 30.0-80.0 g/m², further preferably 35.0-70.0 g/m², and most preferably 38.0-60.0 g/m². Here, basis weight means the average mass per 1 m² (g/m²), and is obtained by taking three test pieces measuring 20 cm×20 cm and prepared according to JIS-L1096 (6. Test Methods, 6.3), measuring the absolute dry mass (g) of each test piece, and determining the corrected mass according to a designated formula.

The thickness of the non-woven fabric used in the present invention is preferably 0.050-0.350 mm, more preferably 0.060-0.300 mm, and most preferably 0.070-0.250 mm. The thickness (mm) is measured according to the measurement method stipulated in JIS-L1096, using a thickness tester on five parts of a prepared sample under an initial load for a fixed duration, with the average of the five values being used.

The tearing strength of the non-woven fabric used in the present invention is preferably 3.0-35.0 N, more preferably 4.0-30.0 N, and most preferably 4.5-25.0 N. For example, when using the printed matter as a bib and the like, even if the bib is attached using a clip and the like, this should not act as the starting point of a tear, and it is therefore necessary for the non-woven fabric to have a high tearing strength. Here, the “tearing strength” (N) of the non-woven fabric can be measured in accordance with JIS-L8116.

The tensile strength of the non-woven fabric used in the present invention is preferably 30 N/5 cm-1000 N/5 cm, more preferably 40 N/5 cm-500 N/5 cm, and most preferably 70 N/5 cm-350 N/5 cm. Here, the “tearing strength” (N/5 cm) of the non-woven fabric can be measured in accordance with JIS-L1096.

The bursting strength of the non-woven fabric used in the present invention is preferably 100-2500 kPa, more preferably 200-1500 kPa, and most preferably 300-900 kPa. The bursting strength of the non-woven fabric can be measured in accordance with JIS-P8112.

In the present invention, optically readable information is printed on the above-mentioned non-woven fabric base material by inkjet printing using an ultraviolet-curable ink. The “ultraviolet-curable ink” used in the present invention can be any type as long as the ink can be cured by being irradiated with ultraviolet radiation, which is a form of actinic radiation. For example, it is possible to use the ultraviolet-curable inks disclosed in Japanese Unexamined Patent Application Publication Nos. 2008-280427, 2007-231082, 2008-81516, and 2008-223014. In order to form clear optically readable information, acrylic ester-based ultraviolet-curable inks are particularly preferred Inks in which the acrylic ester content is approximately 30-45 mass % are particularly preferred as acrylic ester-based ultraviolet-curable inks For example E.I. DuPont's “SD-108” or “SD-111” UV inks can be used, but the ink used in the present invention is not limited to these.

The ultraviolet-curable ink composition used in the present invention may contain a polymerization initiator. The polymerization initiator can be a publicly known one, and using a radical polymerization initiator is particularly preferred. The polymerization initiator used in the ultraviolet-curable ink composition of the present invention is a compound that generates a polymerization-initiating species by absorbing ultraviolet radiation, which is a form of external energy.

Preferred radical polymerization initiators able to be used in the present invention include aromatic ketones, acyl phosphine compounds, aromatic onium salts, organic peroxides, thio compounds, hexaaryl biimidazole compounds, keto-oxime ester compounds, borate compounds, azinium compounds, metallocene compounds, active ester compounds, compounds having carbon-halogen bonds, and alkylamine compounds.

The polymerization initiator in the present invention can be used singly or as a combination of two or more types thereof. Such can be used at a concentration of preferably 0.01-30 parts by mass, more preferably 0.1-20 parts by mass, and further preferably 0.5-10 parts by mass, relative to 100 parts by mass of the ultraviolet-curable ink composition.

A radically polymerizable compound contained in the ultraviolet-curable ink composition of the present invention is a compound having a radically polymerizable ethylenically unsaturated bond, and may be any monomer, oligomer, or polymer as long as the compound has at least one radically polymerizable ethylenically unsaturated bond in the molecule. In addition, the radically polymerizable compound can be used either singly or as a combination of two or more types thereof.

Examples of polymerizable compounds having a radically polymerizable ethylenically unsaturated bond include unsaturated carboxylic acids such as acrylic acid, methacrylic acid, itaconic acid, crotonic acid, isocrotonic acid or maleic acid, or salts thereof, anhydrides having an ethylenically unsaturated group and radically polymerizable compounds such as acrylonitrile, styrene, unsaturated polyesters, unsaturated polyethers, unsaturated polyamides, and unsaturated urethanes.

Specifically, it is possible to use acrylic acid derivatives such as 2-ethylhexyl acrylate, 2-hydroxyethyl acrylate, butoxyethyl acrylate, carbitol acrylate, cyclohexyl acrylate, tetrahydrofurfuryl acrylate, benzyl acrylate, bis(4-acryloxypolyethoxyphenyl)propane, neopentylglycol diacrylate, di(ethylene glycol) diacrylate, tri(ethylene glycol) diacrylate, tetra(ethylene glycol) diacrylate, poly(ethylene glycol) diacrylate, poly(propylene glycol) diacrylate, pentaerythritol triacrylate, pentaerythritol tetraacrylate, dipentaerythritol tetraacrylate, trimethylolpropane triacrylate, tetramethylolmethane tetraacrylate, oligoester acrylates, N-methylol acrylamide, diacetone acrylamide, and epoxy acrylates, methacrylic acid derivatives such as methyl methacrylate, n-butyl methacrylate, 2-ethylhexyl methacrylate, lauryl methacrylate, allyl methacrylate, glycidyl methacrylate, benzyl methacrylate, dimethyl(aminoethyl)methacrylate, 1,6-hexanediol dimethacrylate, ethylene glycol dimethacrylate, tri(ethylene glycol) dimethacrylate, poly(ethylene glycol) dimethacrylate, poly(propylene glycol) dimethacrylate, trimethylolethane trimethacrylate, trimethylolpropane trimethacrylate, and 2,2-bis(4-methacryloxypolyethoxyphenyl)propane, and allyl compounds such as allyl glycidyl ether, diallyl phthalate and triallyl trimellitate. Using an acrylic ester-based compound is particularly preferred.

The total content of radically polymerizable compounds in the ultraviolet-curable ink composition used in the present invention is preferably 1-97 mass %, more preferably 30-95 mass %, and most preferably 30-45 mass %, relative to the overall mass of the ultraviolet-curable ink composition.

It is possible to incorporate a colorant when attempting to form a colored image using the ultraviolet-curable ink composition used in the present invention. The colorant is not particularly limited, and it is possible to select an appropriate publicly known colorant (pigment, dye) according to the intended use of the ink composition. Pigments are preferred from the perspective of weather resistance.

Pigments able to be used in the ultraviolet-curable ink composition used in the present invention are not particularly limited, but it is possible to use, for example, organic or inorganic pigments which have the following numbers and are listed in the color index.

It is possible to use Pigment Red Nos. 3, 5, 19, 22, 31, 38, 43, 48:1, 48:2, 48:3, 48:4, 48:5, 49:1, 53:1, 57:1, 57:2, 58:4, 63:1, 81, 81:1, 81:2, 81:3, 81:4, 88, 104, 108, 112, 122, 123, 144, 146, 149, 166, 168, 169, 170, 177, 178, 179, 184, 185, 208, 216, 226, and 257, Pigment Violet Nos. 3, 19, 23, 29, 30, 37, 50, and 88 and Pigment Orange Nos. 13, 16, 20, and 36 as red or magenta pigments, Pigment Blue Nos. 1, 15, 15:1, 15:2, 15:3, 15:4, 15:6, 16, 17-1, 22, 27, 28, 29, 36, and 60 as blue or cyan pigments, Pigment Green Nos. 7, 26, 36, and 50 as green pigments, Pigment Yellow Nos. 1, 3, 12, 13, 14, 17, 34, 35, 37, 55, 74, 81, 83, 93, 94, 95, 97, 108, 109, 110, 137, 138, 139, 153, 154, 155, 157, 166, 167, 168, 180, 185, and 193 as yellow pigments, Pigment Black Nos. 7, 28, and 26 as black pigments, and Pigment White Nos. 6, 18, and 21 as white pigments according to the intended use of the ink.

It is possible to add a sensitizing dye to the ultraviolet-curable ink composition used in the present invention in order to facilitate decomposition of the polymerization initiator by ultraviolet radiation. The sensitizing dye enters an electronically excited state by absorbing ultraviolet radiation, which is a specific form of actinic radiation. The electronically excited sensitizing dye comes into contact with the polymerization initiator and causes effects such as electron transfer, energy transfer, and heat generation. The polymerization initiator thereby causes a chemical change, that is, decomposes to form a radical, an acid, or a base.

The sensitizing dye should be a compound selected according to the wavelength of the ultraviolet radiation that generates an initiation species in the polymerization initiator used in the ultraviolet-curable ink composition, but by taking into account that this sensitizing dye is used in a curing reaction of an ordinary ultraviolet-curable ink composition, it is possible to cite sensitizing dyes that belong to the following compound types and have absorption wavelengths of 350-450 nm as examples of preferred sensitizing dyes.

Specifically, it is possible to use polycyclic aromatic compounds (for example, pyrene, perylene, triphenylene), xanthene compounds (for example, fluorescein, eosine, erythrosine, rhodamine B, rose bengal), cyanine compounds (for example, thiacarbocyanine, oxacarbocyanine), merocyanine compounds (for example, merocyanine, carbomerocyanine), thiazine compounds (for example, thionine, methylene blue, toluidine blue), acridine compound (for example, acridine orange, chloroflavin, acriflavin), anthraquinone compounds (for example, anthraquinone), squalium compounds (for example, squalium), coumarin compounds (for example, 7-diethylamino-4-methyl coumarin) and the like.

Because the ultraviolet-curable ink composition used in the present invention is an ultraviolet-curable type, it is preferable not to incorporate a solvent so that a reaction occurs and the ink is cured immediately after the ink composition strikes the base material. However, it is possible to incorporate a prescribed solvent as long as this solvent does not affect the curing rate etc. of the ink composition. An organic solvent or water can be used as the solvent. In particular, organic solvents improve the adhesion of the ink composition to the recording medium (a support such as a non-woven fabric or paper), and can therefore be added.

The quantity of organic solvent is, for example, 0.1-5 mass %, and preferably 0.1-3 mass %, of the overall ultraviolet-curable ink composition used in the present invention.

In addition, it is possible to add other publicly known compounds as required to the ultraviolet-curable ink composition used in the present invention. For example, it is possible to appropriately select and add surfactants, leveling additives, matting agents, as well as polyester resins, polyurethane resins, vinyl resins, acrylic resins, rubbery resins, and waxes for adjusting the film properties.

The “optically readable information” printed using the ultraviolet-curable ink means one-dimensionally, two-dimensionally, or three-dimensionally encoded information, for example, information that cannot be deciphered (decoded) by a human being but can be deciphered (decoded) by a dedicated reader, such as a bar code, QR Code, Data Matrix, PDF417, Maxi Code, or VeriCode. In addition, examples of specific information that is associated with the optically readable information and stored in a database includes the name, family name, age, address, gender, telephone number (landline and cell phone), e-mail address, emergency contact, nationality, blood type, medical history, clinical history and prescribed emergency treatment of the printed matter user, the name of the sporting event or race, and the cloakroom number for belongings handed in by the participant during the event.

In the present invention, in addition to the optically readable information printed using the ultraviolet-curable ink, information that can be deciphered by a human being, that is, visually recognizable information, may also be printed on the same non-woven fabric base material. This does not need to be printed by inkjet printing, but printing by inkjet printing using an ultraviolet-curable ink is preferred. This type of visually recognizable information is not particularly limited, but is preferably not information that should not be visually recognizable from the perspective of protection of personal information, and can be the name of the event or race, the logo of the event or race, the identification number of the printed matter user, a portrait of the printed matter user and the like.

In the present invention, it is possible to also print tactilely recognizable information on the non-woven fabric base material on which the optically readable information and, optionally, the visually recognizable information is printed. This tactilely recognizable information does not need to be printed by inkjet printing, but printing a three-dimensional pattern by inkjet printing using an ultraviolet-curable ink is preferred. This type of tactilely recognizable information can be, for example, Braille.

The type of printed matter of the present invention is not particularly limited, but is preferably an individual distinguishing mark. The individual distinguishing mark can be a bib for an event or race or an admission ticket to an amusement park and the like, but is not limited to these. A bib is a particularly preferred individual distinguishing mark.

A printed matter set of the present invention should contain a plurality of, that is, two or more printed matters. In addition, the printed matter set of the present invention does not necessarily have to be printed at the same time or on the same day, and should be two or more printed matters relating to identical or similar events or races. The printed matter set of the present invention is such that each printed matter in the set should contain optically readable information that displays information that is different from the other printed matters in the set and visually recognizable information that is common to all the printed matters in the set, may contain optically readable information that is common to two or more of the printed matters in the set, and may contain visually recognizable information that displays information that is different from the other printed matters in the set.

For example, when used as a bib for a marathon and the like, it is possible to visually recognize the name and the logo of the marathon as information that is common to all the printed matters in the printed matter set and simultaneously recognize information such as personal information, which is preferably optically readable information, as optically readable information that displays information that varies between the printed matters in the set.

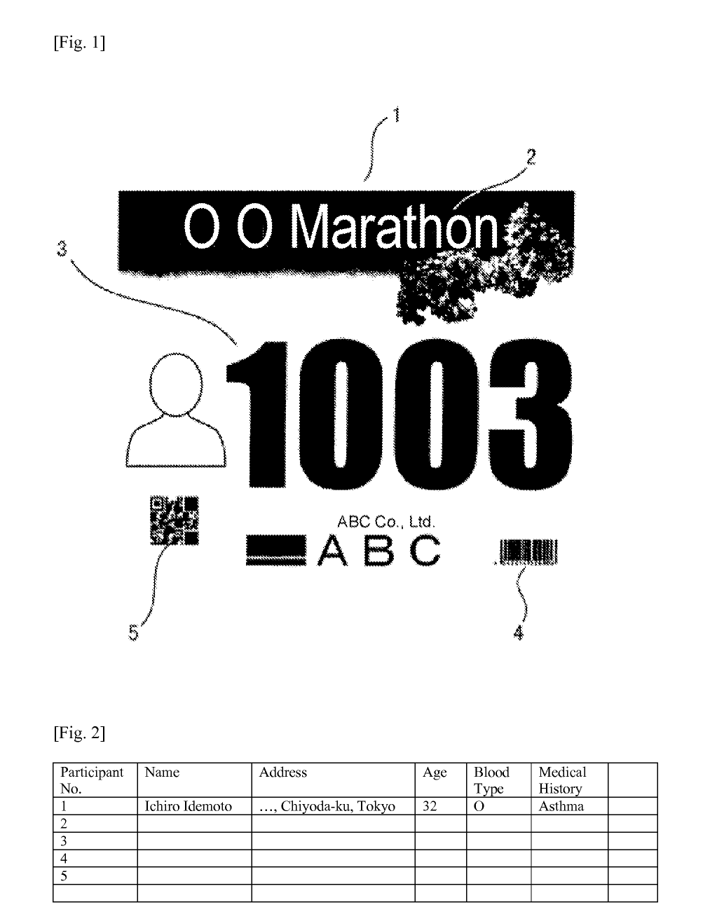

A method for producing a bib, which is an example of an embodiment of the printed matter of the present invention, will now be explained. FIG. 1 is a diagram showing an embodiment of a bib (1) of the present invention. The bib (1) is a bib for a marathon and the number of bibs prepared is at least the number of participants in the marathon.

As shown in FIG. 1, the name (2) of the marathon, the bib number (3), a bar code (4), and a QR Code (5) are printed on the bib (1). The name (2) of the marathon is common to all the bibs, whereas the bib number (3), the bar code (4), and the QR Code (5) are different for each bib.

The bar code (4) and the QR Code (5) relate to personal information stored in a database, such as the address, name, age, blood type, and medical history of the bib wearer, and this personal information for the bib wearer can be read by a bar code reader.

Firstly, data for preparing the bar code is generated. Personal information such as the address, name, age, blood group, and medical history of each participant, which is obtained from the items filled in on the entry form, is associated with a participant number (individual identification information), as shown in FIG. 2, so as to prepare a database that stores this information, which is then stored by a storage means.

Next, a bar code signal for printing a bar code (optically readable information) corresponding to the participant number is generated for each participant number.

A printing operation is then carried out. Using software such as Adobe Illustrator™, combined digital data is prepared for each participant (each bib) from a signal for printing the name (2) of the marathon, a signal for printing a specified participant's bib number (3), and a signal for printing a bar code (4), and a QR Code (5) corresponding to the specified participant's participant number (personal identification information).

Next, this data is sent to an inkjet printer and the name (2) of the marathon, the bib number (3), the bar code (4), and the QR Code (5) are printed on the surface of the above-mentioned non-woven fabric using an above-mentioned ultraviolet-curable ink.

It is possible to form Braille information with the ultraviolet-curable ink on the non-woven fabric instead of, or in addition to, the bar code (4) and/or the QR Code (5).

### EMBODIMENTS

The present invention will be now be explained in greater detail through the use of embodiments, but is in no way limited by these embodiments.

### Embodiment 1

A bib for a marathon was prepared using the following procedure.

A Tyvek™ non-woven fabric (product name 1056D) manufactured by E.I. DuPont (basis weight: 52.5-57.5 g/m², thickness 0.110-0.230 mm, tearing strength 4.8-9.8 N/5 cm) was cut to a size of 245×280 mm. When preparing the finished bib (200×40 mm) on an automatic cutting machine attached to a printer, register mark parts (markers for indicating the top and bottom, the position equidistant from the left and right, and the four corners of the block copy, which are used to determine the positions at which the block copy is to be cut to the finished size or for multi-color printing registering) were formed. The name of the marathon and the number, a photograph, and the name (in alphabetical notation) of the runner were collated as visually recognizable information to be embedded in the bib. In addition, the runner's name (in Chinese characters), family name, age, address, gender, telephone number (landline and cellphone), emergency contact, nationality, blood type, participating race, medical history, clinical history, prescribed emergency treatment and cloakroom number for belongings handed in during the event were collated as virtual information to be embedded as optically readable information.

A database was created by associating this virtual information with the participant's personal identification information, and it was possible to read the information from the database by using a bar code reader to read the bar code or QR Code™ printed on the bib.

Digital data that combines these into a single image was prepared for each runner Using Adobe™ Illustrator™. Using a Roland D.C. Versa UV LEC-300 and a DuPont E.I. acrylic ester-based UV-curable ink for inkjet printers (SD-108), which contains approximately 30-45 mass % of acrylic esters, the above-mentioned digital data was printed on the non-woven fabric so as to obtain bibs that were customized for each runner.

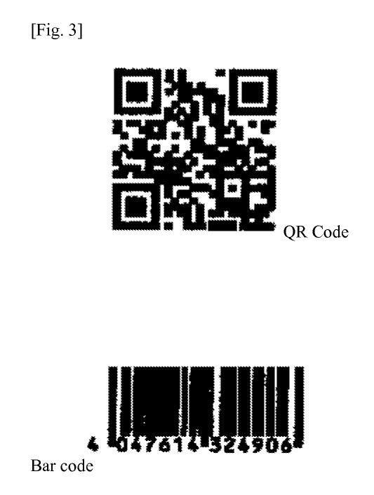

Enlarged photographs of the bar code and QR Code™ parts of one of the obtained bibs are shown in FIG. 3. As shown in FIG. 3, the edges of the bar code and QR Code™ on the bib are clear and free of blurring, and images that can be easily detected by an optical device were formed. In addition, the hue and brightness were particularly excellent.

### Embodiment 2

A bib was obtained in the same way as in embodiment 1, except that a Tyvek™ non-woven fabric (product name 1443R) manufactured by E.I. DuPont (basis weight: 41.0-45.0 g/m², thickness 0.080-0.200 mm, tearing strength 9.8-22.5 N/5 cm) was used as the non-woven fabric. In the same way as embodiment 1, the edges of the bar code and QR Code™ are clear and free of blurring, and images that can be easily detected by an optical device were formed. In addition, the hue and brightness were excellent.

### Comparative Example 1

A Tyvek™ non-woven fabric (product name 1056D) manufactured by E.I. DuPont was cut to a size of 245×280 mm. Using a commercially available inkjet printer (Pixus 455i manufactured by Canon, Inc.) and non-ultraviolet-curable inks (BCI-24 Color and BCI-24 Black), the same digital data as that in embodiment 1 was printed on the non-woven fabric so as to obtain bibs that were customized for each runner.

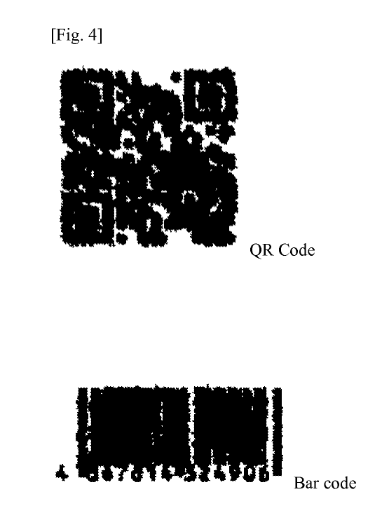

Enlarged photographs of the bar code and QR Code™ parts of one of the obtained bibs are shown in FIG. 4. As shown in FIG. 4, the edges of the bar code and QR Code™ are blurred, some bars cannot be distinguished from adjacent bars, and detection by an optical device was not possible. In addition, the hue and brightness were clearly inferior to the bibs obtained in embodiments 1 and 2.

1. A printed matter comprising a non-woven fabric base material having a basis weight of 20.0-120.0 g/m² and a thickness of 0.020-0.400 mm, and optically readable information formed by printing an ultraviolet-curable ink on this base material using an inkjet printing method.

2. The printed matter according to claim 1, wherein the non-woven fabric base material has a tearing strength of 3.0-35.0 N.

3. The printed matter according to claim 1 or claim 2, further comprising visually recognizable information formed on the base material by printing with an ultraviolet-curable ink using an inkjet printing method.

4. The printed matter according to any of claims 1-3, further comprising tactilely recognizable information formed on the base material by printing with an ultraviolet-curable ink using an inkjet printing method.

5. The printed matter according to any of claims 1-4, the printed matter being an individual distinguishing mark.

6. The printed matter according to any one of claims 1-5, wherein the individual distinguishing mark is a bib.

7. A printed matter set containing a plurality of the printed matters according to any one of claims 1-6, wherein each of the printed matters in the set comprises optically readable information that displays information that is different from the other printed matters in the set and visually recognizable information that is common to all the printed matters in the set.

8. A method for producing a printed matter set consisting of a plurality of printed matters on each of which is printed optically readable information that displays information that is different from that on other printed matters in the set, comprising:
a step of entering one of the mutually differing types of information,
a step of converting the entered information into a signal for generating optically readable information corresponding to the entered information,
a step of sending the aforementioned signal to a printing means and,
based on the aforementioned signal, a step of printing the aforementioned optically readable information on a non-woven fabric base material having a basis weight of 20.0-120.0 g/m² and a thickness of 0.020-0.400 mm with an ultraviolet-curable ink using an inkjet printing method.
